(19) United States
(12) Patent Application Publication
(10) Pub. No.: US 2003/0182388 A1
(43) Pub. Date: Sep. 25, 2003

(54) Method and system for portable persistent clipboard function

(76) Inventors: Geoffrey D. Alexander, Chapel Hill, NC (US); David B. Lection, Raleigh, NC (US); Eric L. Masselle, Raleigh, NC (US); Martin J.C. Presler-Marshall, Chapel Hill, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 10/101,896

(22) Filed: Mar. 20, 2002

(51) Int. Cl. G06F 15/167

(52) U.S. Cl. 709/213; 709/312

(57) ABSTRACT

A portable, persistent clipboard is disclosed that enables the automatic storage of clipboard data in an “off-machine” storage area accessible to a user of one or more workstations. The off-machine storage area can comprise a floppy disk, CDR or CD-RW, a keychain memory device, or a web storage area accessible over the Internet. If desired, the format of the stored clipboard data can be transcoded to a different format prior to retrieval by a workstation.

### BACKGROUND OF THE INVENTION

1. Field of the Invention

The present invention generally relates to graphical user interfaces for computer systems, and in particular to a method and system providing external, portable and/or remotely-accessible storage and retrieval of clipboard data.

2. Description of the Related Art

Most operating systems for workstations, such as OS/2™, AIX™, Windows™, Linux™, and MacOS™, provide some form of access to a “clipboard” function that allows users of a workstation to copy, cut, and paste selected data from one application to another or within the same application. This function is used extensively because it allows the user to avoid re-entering data already present on the workstation. Generally, all kinds of data, including text, graphics, equations, and tables, can be transferred to and from the clipboard function.

A clipboard is a special memory resource owned and managed by the operating system or by a windowing system operating in conjunction with the operating system (e.g., Linux with X Windows). In many prior art systems, the clipboard memory is allocated from memory residing on the same workstation as the application programs using the clipboard function. It is also known to share clipboard memory between networked workstations, so that the clipboard content stored in the clipboard memory of one workstation in the network can be shared with other workstations in the network. The terms “local clipboard” and “machine-specific clipboard” are used herein to describe these prior art clipboard memories that reside on individual workstations, and the term “shared clipboard” is used to describe prior art clipboard memories that can be shared across networked machines.

A clipboard is considered “global” in nature if all clipboard-enabled applications on a particular workstation share the same local clipboard. If each application uses its own clipboard, the clipboard is considered to be “process-specific” in nature. A clipboard-enabled application is typically available to the end user via three edit operations called “cut”, “copy”, and “paste.” Terms such as “cut”, “copy”, and “paste” are well known and commonly utilized in the art of computer clipboard-enabled applications. The “cut” edit operation provides a way for the user of an application program to move selected data from that application program into the local clipboard. The “copy” edit operation provides a way for the user of an application program to place a copy of selected data from that application program into the local clipboard. The “paste” edit operation provides a way for the user of an application program to place a copy of the contents of the local clipboard into that application program. An application program specifically written to provide support for the clipboard using clipboard APIs is integrated with the operating system, enabling the clipboard to operate as described.

Prior to copying or cutting the data into the local clipboard memory, the data must be selected. The user generally uses the keyboard or mouse to select the desired data from a screen display. Then, the user invokes either the copy or cut command, and the selected data is transferred by the operating system into the local clipboard memory. The user then selects a location in the same program or a different program using the mouse pointer. Thereafter, the user either selects the “paste” command from an “Edit” menu or enters a control key combination, such as CTL+V, to cause the data stored in the local clipboard memory to be copied to the insertion location. The details of operation of the computer system to perform the cut, copy, and paste functions are well-known and are not described further herein. Local clipboards simplify computer operations by allowing a user to locate and clip repetitively-used information once and then with a few clicks of a mouse, repeatedly insert the data in an unlimited number of locations across multiple programs.

Prior art operating systems implement the local clipboard such that data retrieval operations (“paste” edit operations) typically leave the contents of the local clipboard intact, while data store operations (“cut” and “copy” edit operations) typically overwrite the prior contents of the local clipboard. Some systems have implemented “multiple clipboard” functionality whereby, with certain limitations, multiple blocks of clipboard content may be saved separately. For example, Microsoft Office allows up to 12 items (blocks) of clipboard data to be stored in the Office clipboard and pasted into other Microsoft Office applications. Similarly, Corel WordPerfect offers the SaveGet function whereby multiple blocks of text can be saved in the local clipboard for later use within WordPerfect. The ability to append data to a particular clipboard item has also been provided in the prior art. The copied data generally remains in the clipboard memory until it is replaced with another selected portion. Only if the user performs another copy or cut command will the contents of the clipboard memory be replaced or overwritten (for a clipboard having multiple clipboard functionality, the overwriting does not take place until all clipboards are used).

Typically, once the user of a workstation shuts down the workstation, all clipboard data is lost, i.e., clipboard memory of the prior art is typically not persistent memory. However, products have been developed that provide for persistent clipboard memory across reboots. For example, “Clipboard Manager” by Chaotic Software (Saratoga, Calif.) enables the creation of multiple clipboards, switching between clipboards, and provides persistent clipboards across reboots for Apple™ computers. Other systems allow the contents of the clipboard to be saved to a file. This allows the user to subsequently retrieve the file and use the clipboard data again for pasting into applications. However, if the user fails to save the clipboard data to a file, the clipboard data is lost when a system reboot is performed. Further, in order to use the saved clipboard data, the user must find and load the file, i.e., the clipboard operation is not automatic and is essentially the same as a typical file retrieval operation.

With the proliferation of relatively inexpensive and/or highly portable workstations (desktop computers, laptop and palmtop computers, PDA's, etc.) and the ease with which workstations can be interconnected via traditional networks and the Internet, it is now commonplace for a single computer user to have multiple workstations available for use. Very often a computer user might start a project on one workstation in the morning (e.g., at a traditional office), continue working on the same project on the road (e.g. via a laptop or a PDA on a plane, in a hotel, or at a customer location), and finish the work day by continuing to work on the same project at third location (e.g., at a home office). While this provides the computer user with great flexibility, it also typically requires the conducting of multiple “saves” of the project throughout the day to floppy or CD drives, a USB storage device, a network storage location, or other location that is accessible to the multiple workstations being used.

Since, as noted above, clipboard data is available only so long as the workstation on which the clipboard enabled program resides is being used by the user (and the clipboard data may be lost when that workstation is shut down), once the mobile user switches workstations or shuts down one of his or her workstations that has not been enabled for persistent clipboard memory (e.g., prior to traveling to the next workstation), any clipboard data stored in the clipboard memory is unavailable. This results in inefficiency for the workstation user, since they will have to remember what clipboard content they were previously using and then locate and “reclip” the same content again.

What is needed, therefore, is a simple and efficient manner of implementing a portable persistent clipboard that is available for use among multiple workstations.

### SUMMARY OF THE INVENTION

The present invention is a portable, persistent clipboard that enables the automatic storage of clipboard data in an “off-machine” storage area accessible to a user of one or more workstations. In preferred embodiments the off-machine storage area comprises a floppy disk, CDR or CD-RW, a keychain memory device, or a web storage area or web service accessible over the Internet. Thus, a global, machine-independent, persistent clipboard is available, in a portable manner, to enable access to an archive of clipboard content from any workstation being used by a user, regardless as to which workstation originated the clipboard content.

### BRIEF DESCRIPTION OF THE DRAWINGS

FIG. 1 is a pictorial representation of a computer system which may be utilized to implement a preferred embodiment of the present invention;

FIG. 2 depicts a representative hardware environment of the computer system illustrated in FIG. 1;

FIG. 3 illustrates an environment in which a typical user might use the present invention;

FIG. 4 is a flowchart illustrating an example of steps to be performed in accordance with the present invention; and

FIG. 5 illustrates an alternative embodiment of the present invention in which web-storage is provided to store clipboard data in accordance with the present invention.

### DETAILED DESCRIPTION OF THE PREFERRED EMBODIMENTS

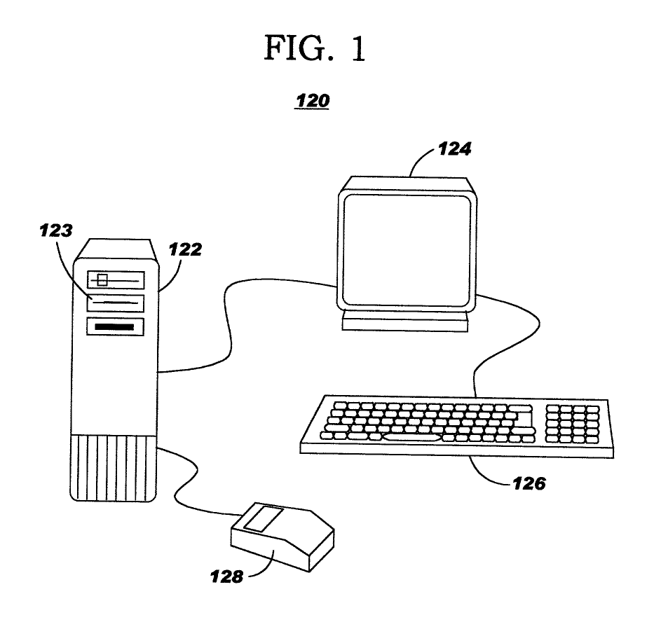

With reference now to the figures and in particular with reference to FIG. 1, there is depicted a pictorial representation of a computer system which may be utilized to implement a preferred embodiment of the present invention. A computer system 120 is depicted that includes a system unit 122, a video display 124, a keyboard 126, and a mouse 128. System unit 122 typically comprises a housing containing one or more disk drives, a central processing unit (CPU), sound and video hardware, hardware interfaces and the like.

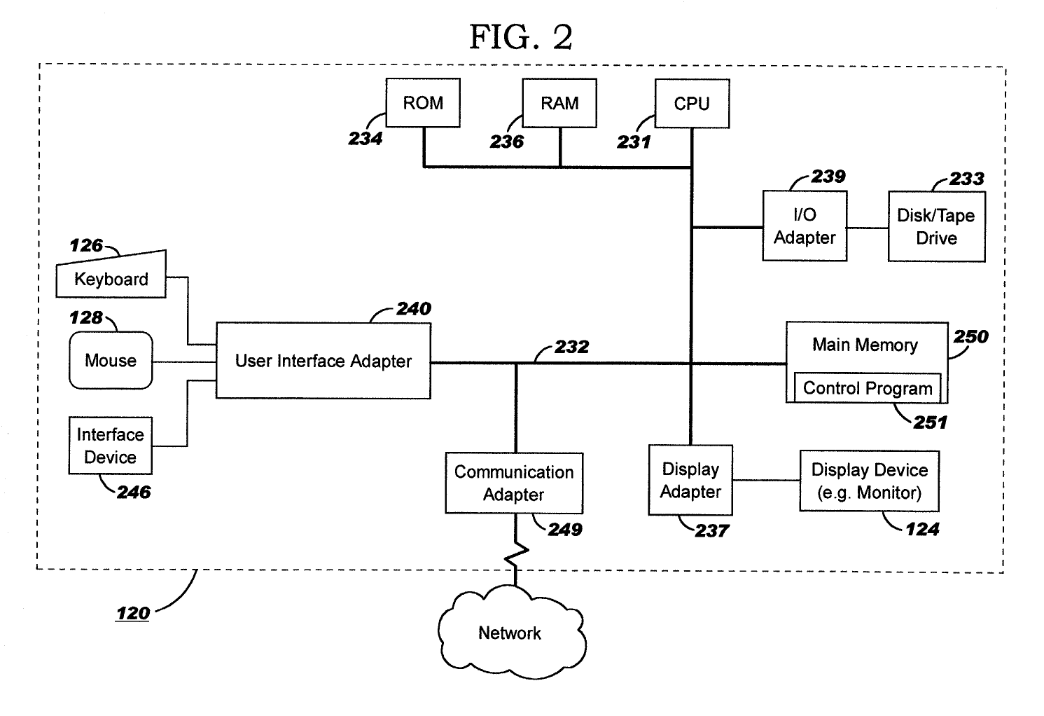

Computer system 120 can be implemented utilizing any suitable computer such as ThinkPad™, NetVista™, or Netfinity™ computers, all products of International Business Machines Corporation, located in Armonk, N.Y. However, those skilled in the art will appreciate that a preferred embodiment of the present invention can apply to any computer system, regardless of whether the computer system is a complicated multi-user computing apparatus or a single-user workstation or a network computer. In FIG. 1 and FIG. 2, like parts are identified by like numbers. Computer system 120 is thus a configuration that includes all functional components of a computer and its associated hardware. In general, a typical computer system includes a console or system unit such as system unit 122, with one or more disk drives 123, a monitor such as video display 124, and a keyboard such as keyboard 126. Additional hardware, often referred to in the art as peripheral devices, can include devices such as printers, modems, and joysticks.

FIG. 2 depicts a representative hardware environment of the computer system illustrated in FIG. 1. Computer system 120 includes a Central Processing Unit (“CPU”) 231, such as a conventional microprocessor, and a number of other units interconnected via system bus 232. CPU 231 includes a portion of computer system 120 that controls the operation of the entire computer system, including executing the arithmetical and logical functions contained in a particular computer program. Although not depicted in FIG. 2, CPUs such as CPU 231 typically include a control unit that organizes data and program storage in a computer memory and transfers the data and other information between the various parts of the computer system. Such CPUs also generally include an arithmetic unit that executes the arithmetical and logical operations, such as addition, comparison, multiplications and so forth. Such components and units of computer system 120 can be implemented in a system unit such as system unit 122 of FIG. 1.

Computer system 120 further includes random-access memory (RAM) 234, read-only memory (ROM) 236, display adapter 237 for connecting system bus 232 to video display 124, and I/O adapter 239 for connecting peripheral devices (e.g., disk and tape drives 233) to system bus 232. As is well known I/O adapter 239 can be of a variety of configurations (e.g., a Universal Serial Bus (USB) port) and a typical computer system will have multiple I/O adapters.

Video display 124 is the visual output of computer system 120. Video display 124 can be a cathode-ray tube (CRT) based video display well-known in the art of computer hardware. However, with a portable or notebook-based computer, video display 124 can be replaced with a liquid crystal display (LCD) based or gas plasma-based flat-panel display. Computer system 120 further includes user interface adapter 240 for connecting keyboard 126, mouse 128, and/or other user interface devices 246, such as a touchscreen device, speaker, microphone, etc, to system bus 232. Communications adapter 249 connects computer system 120 to a computer network. Although computer system 120 is shown to contain only a single CPU and a single system bus, it should be understood that the present invention applies equally to computer systems that have multiple CPUs and to computer systems that have multiple buses that each perform different functions in different ways.

Computer system 120 also includes an interface that resides within a machine-readable media to direct the operation of computer system 120. Any suitable machine-readable media may retain the interface, such as RAM 234, ROM 236, a magnetic diskette, magnetic tape, or optical disk (the last three being located in disk and tape drives 233). Any suitable operating system and associated interface (e.g., Microsoft Windows) may direct CPU 231. For example, the AIX operating system and AIXwindows windowing system can direct CPU 231. The AIX operating system is IBM's implementation of the UNIX™ operating system. “UNIX” is a trademark of UNIX Systems Laboratories, Inc. Other technologies also can be utilized in conjunction with CPU 231, such as touch-screen technology or human voice control. Operating systems typically include computer software for controlling the allocation and usage of hardware resources such as memory, CPU time, disk space, and peripheral devices. The operating system is the foundation upon which applications, such as word-processing, spreadsheet, and web browser programs are built.

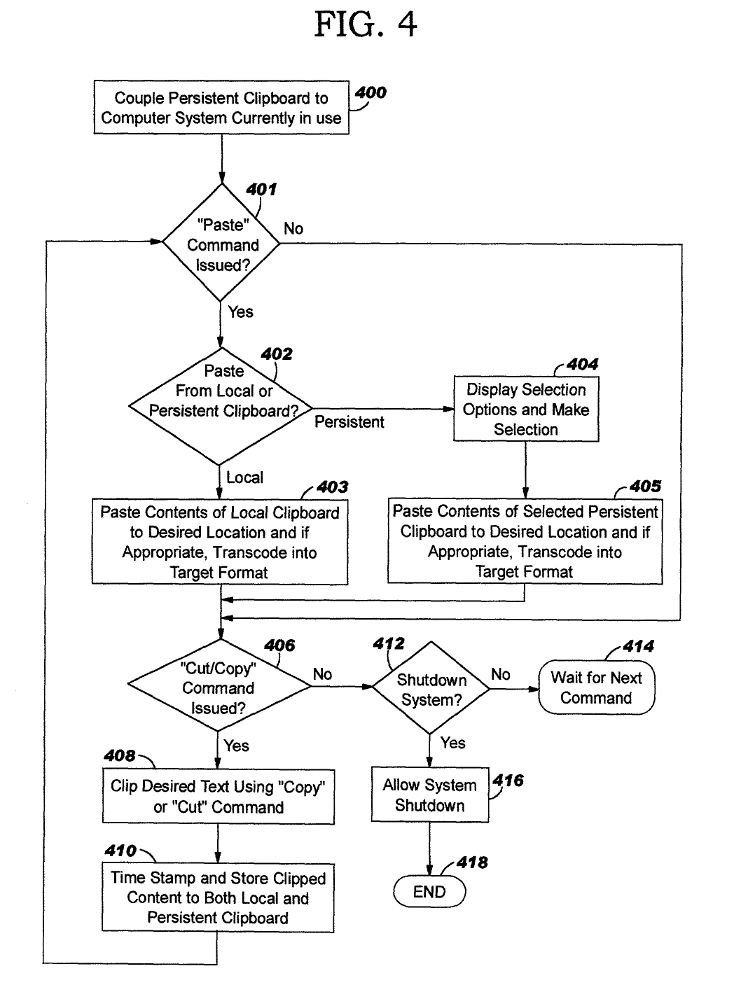

Those skilled in the art will appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted. In addition, main memory 250 is connected to system bus 232, and includes a control program 251. Control program 251 resides within main memory 250, and contains instructions that, when executed on CPU 231, carries out the operations depicted in the logic flowchart of FIG. 4 described herein. The computer program product also can be referred to as a program product.

While the present invention has been (and will continue to be) described in the context of a fully functional computer system, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links. Examples of transmission media include devices such as modems. Modems are communication devices that enable computers such as computer 120 depicted in FIG. 1 and FIG. 2 to transmit information over standard telephone lines.

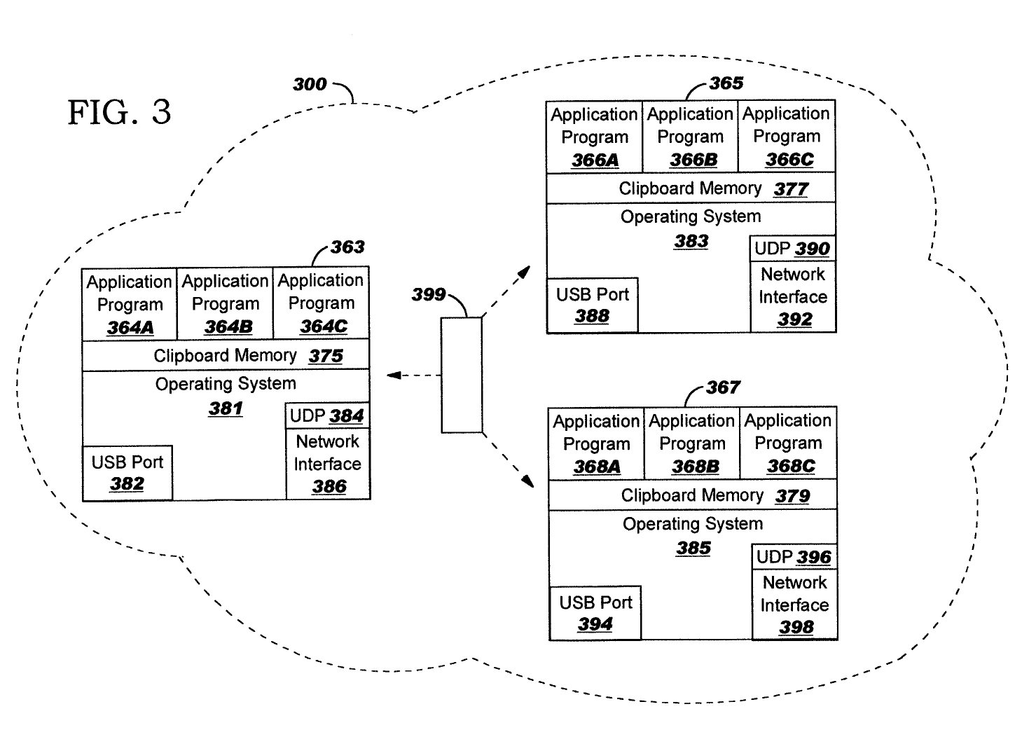

FIG. 3 illustrates an environment 300 in which a typical user might use the present invention. It is understood and contemplated that in the environment of the present invention, a user may have access to two or more workstations on a regular basis. In FIG. 3, three workstations 363, 365, and 367 are shown. Each workstation typically would comprise a processor, such as a computer or PDA and each processor would contain application programs. In the example of FIG. 3, workstation 363 is an office desktop, workstation 365 is a laptop computer, and workstation 367 is a desktop computer located in a user's home office.

The application programs are computer programs designed to assist users in performing certain types of work. An application program is different from an operating system, which runs a computer, and a utility, which performs maintenance or general purpose chores. An application program also differs from a language with which computer programs are created. Depending on the work for which it was designed, an application program can manipulate text, numbers, graphics, sound files, video files, or a combination of such elements. Some application programs, such as word processors, offer considerable computing power by focusing on a single task, such as word processing. Other applications, referred to often as integrated software, offer less power but include several application programs, such as a word processor, spreadsheet, and database program.

Thus, referring to FIG. 3, workstation 363 includes a first application program 364A, a second application program 364B, and a third application program 364C. A clipboard memory 375 is also provided to provide a memory location for storage of clipboard content. In addition, workstation 363 contains an individual operating system 381, and a User Datagram Protocol (UDP) port 384 and network interface 386, both well known in the art of communications protocols. As is standard in most computer systems today, workstation 363 also includes a USB port 382, a “plug-and-play” port enabling the connection and operation of a broad range of devices in a well known manner. Workstations 365 and 367 contain the same functional elements in this example (workstation 365: application programs 366A-366C, clipboard memory 377, operating system 383, USB port 388, UDP port 390 and network interface 392; workstation 367: application programs 368A-368C, clipboard memory 379, operating system 385, USB port 394, UDP port 396, and network interface 398).

The following discussion is directed to workstation 363; however, it is understood that the functional operation of any of the workstations is essentially the same.

The UDP port 384 and network interface 386 cooperate in a well known manner to provide workstation 363 with access to other systems via modem/telephone line connections, cable modem connections, network connections, and the like. In a typical application of the present invention, a user of workstation 363 would use the UDP port 384/network interface 386 combination to connect remotely to a network of an employer or a customer and/or to connect to the internet. The connection would be a constant connection, as in a typical LAN environment in an office, or it could be an “on demand” connection, such as a dial-up connection to a network from a laptop or home office.

In accordance with a first embodiment of the present invention, workstation 363 must also have access to means for storing data to an external, portable (i.e., off-workstation and easily transportable but accessible by the workstation) storage medium. This can comprise a floppy disk usable in connection with disk drive 233 of FIG. 2, or a writable CD usable in connection with a CDR or CD-RW, or a USB storage device or a web-based storage area whereby a user of the workstation can access the storage area via an Internet connection as needed, all of which are well known external, portable storage media. In a preferred embodiment, the portable storage medium comprises a keychain memory device 399, such as the IBM USB Memory Key™, a portable USB storage device that allows the sharing of data between any systems having a functional USB port.

The general concept of the present invention is as follows. A user, User A, begins her work day by arriving at the office and logging on to workstation 364A. In this example, workstation 363A is an office computer located at the main headquarters of her company. While using workstation 363A, User A utilizes the clipboard function to save one or more clipboard content files to the clipboard memory 375 of workstation 363A. In accordance with the present invention, her action of storing any clipboard content to clipboard memory 375 automatically stores the same clipboard data to keychain memory device 399. As noted above, keychain memory device 399 stores the persistent clipboard copy of the clipboard data to a portable storage device. Each time User A performs a new cut/copy operation to the local clipboard, a copy of the same clipboard content is saved, cumulatively, to the portable persistent clipboard.

At 11:00 AM, User A departs the office and workstation 363A, taking with her the portable storage medium on which the clipboard data has been saved (keychain memory device 399 in this example). At this point in the example, User A boards a plane, sets up her laptop computer (workstation 365B), inserts the portable storage medium into the laptop computer, and continues working. Since User A has access to the portable storage medium via workstation 365B, she has continual access to the same clipboard data that she was using while at workstation 365A in the home office, via the benefit of having the clipboard data stored on the portable storage medium. User A can continue to work on the project, having access to all of the clipboard information as she travels, and all new clipboard information is automatically stored on the portable storage medium.

Upon completion of the business trip, User A returns home to her residence. Here she has access to workstation 367C in her home office. Again, since she has in her possession the portable storage medium containing the persistent clipboard data, by inserting the portable storage means into her home workstation 367C, again, she has access to all of the clipboard data as it existed when she last shut down her laptop (workstation 367B).

FIG. 4 is a flowchart illustrating an example of steps to be performed in accordance with the present invention. As noted above, these steps can be performed using a computer configured to perform these steps and/or using a computer program product that configures a computer system for operation in accordance with these steps. The programming code used will vary from programmer to programmer and language to language; it is understood that the steps illustrated in FIG. 4 provide a programmer of ordinary skill in the art with the information needed to be able to configure a computer system and/or develop computer code to embody the present invention.

Referring to FIG. 4, at step 400, as an initial step, the persistent clipboard is coupled to the computer system currently in use by a user. For example, in the previous example discussed above, User A will insert the portable storage medium containing the persistent clipboard data (e.g., the keychain memory device 399) into the appropriate interface (e.g., the USB port) of a computer system currently being used.

The portable storage medium is configured in a known manner so that, upon insertion into the computer system, a procedure is automatically instituted that makes the portable persistent clipboard content available for use on the computer system. Methods for making the portable persistent clipboard content available to the computer system in use are known to programmers of ordinary skill in the art and it is understood that other methods of performing this function may be known and used and fall within the scope of the present invention.

At step 401, the system is queried to determine if the “paste from clipboard” command has been issued. This command will be issued when the user wishes to take text from either the local or persistent clipboard and insert it into the application file in use.

If the response to the query at step 401 is “yes”, then at step 402, a determination is made as to whether or not the user wishes to paste from the local clipboard or the persistent clipboard. This can be accomplished in a variety of known ways, for example, by assigning a unique key combination (e.g., Ctrl-v for a paste from the local clipboard and Ctrl-Alt-v for a paste from the persistent clipboard), or giving the user access to a drop-down menu containing “paste from local clipboard” or “paste from persistent clipboard” as a selection option. The operation of the local clipboard, from the perspective of the user, remains unchanged.

If at step 402 it is determined that the user wishes to paste from the local clipboard, then the process proceeds to step 403, where the contents of the local clipboard are pasted to the desired location.

If, at step 402 a it is determined that the user wishes to paste from the persistent clipboard, the process proceeds to step 404. At step 404, the user is given the option of selecting from a list of the accumulated clipped content stored in the persistent clipboard, if the persistent clipboard contains multiple “clips”. The user selects from among the selection options, and at step 405, the contents of the selected persistent clipboard are pasted to the desired location in the text. As discussed further below, if the format of the selected persistent clipboard requires transcoding prior to pasting to the desired location, the transcoding into the target format takes place at this point.

If, at step 401, a determination is made that a paste command has not been issued, then the process skips step 404 and proceeds to step 406.

At step 406, a query is made as to whether or not a “cut/copy” command has been issued. If the answer is in the affirmative, then at step 408, the desired text is clipped using the standard copy or cut command, and at step 410, the clipped content is time-stamped in a known manner and then stored both to the local clipboard (as is done in the prior art) as well as to the portable persistent clipboard, in accordance with the present invention. The process proceeds back to step 402 to await the issuance of a paste command to enable pasting of the now-stored data to the desired location.

As can be seen, since the clipped content is automatically stored to the portable persistent clipboard at step 410, the portable storage medium always contains the most recent clipboard data.

If the query at step 406 indicates that no cut/copy command was issued, at step 412 a determination is made as to whether or not a system shutdown request has been issued. If no system shutdown request has been issued, then at step 414, the system waits for a new command to perform additional operations.

If, however, at step 412, it is determined that a system shutdown request has been made, then at step 416, the system is allowed to be shutdown, and at step 418 the process ends.

As a result of the above process, a user of the portable storage medium will always be able to carry, from system to system, a copy of the most recent clipboard data (in the form of the portable persistent clipboard information contained on the portable storage medium), and when operating a different computer in conjunction with the portable storage medium, that new computer system will be updated immediately with the portable persistent clipboard data. Thus, using the present invention, User A of the above example will always have access to the most recent clipboard information and, if desired, an archive of older clipboard information as well.

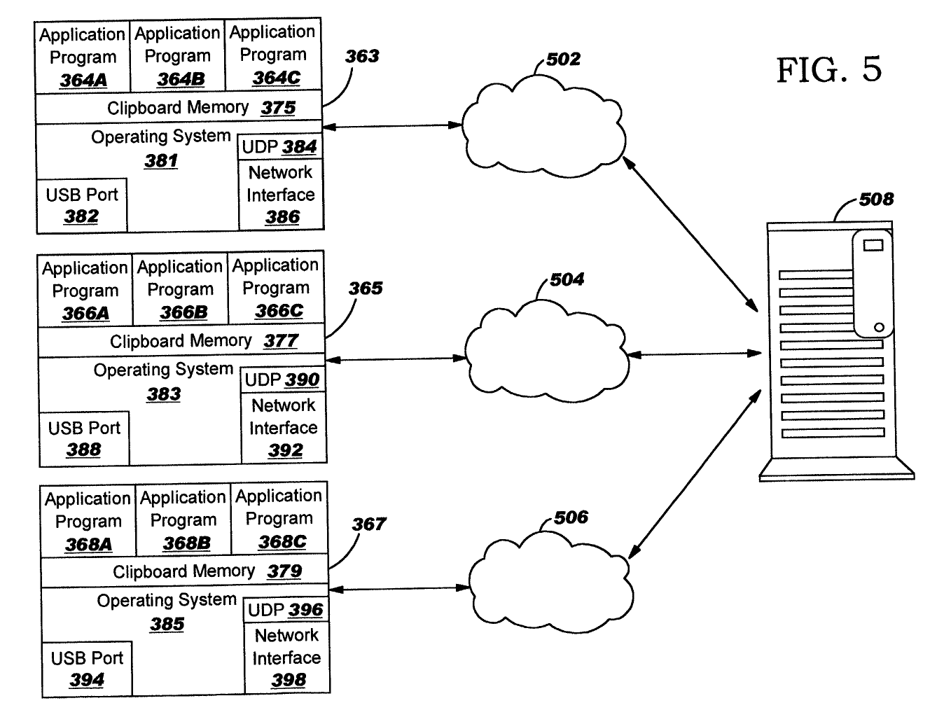

FIG. 5 illustrates an alternative embodiment of the present invention. In accordance with this alternative embodiment, rather than storing the persistent clipboard data on a portable storage medium that is carried with the user, the persistent clipboard data is stored to and retrieved from a web server or web service accessible remotely over a network connection such as the Internet. In the preferred embodiment, the web server or web service is maintained and operated by a third party at a location remote from any of the various workstations used by the multi-workstation user. Thus, for example, referring to FIG. 5, workstations 363, 365, and 367 are independently connectable to a web server 508 via network connections 502, 504, or 506, respectively. Web server 508 is a third party web server unrelated and uncontrolled by User A or User A's employer. Thus, failure of any of User A's workstations or any network hardware or software owned or operated by User A's employer will not affect web server 508 or any content stored thereon.

In accordance with this second embodiment of the present invention, when User A accesses a program that has clipboard capability, a connection is automatically established (or attempted to be established) between that particular workstation and web server 508. The purpose of this connection is to make available to the workstation the most recently stored persistent clipboard content so that it will be available for use at the workstation being used by User A, and to allow clipboard content to be stored to the persistent clipboard on web server 508.

The same process applies to each of the workstations used by User A. Thus, as long as User A has access to web server 508 from a workstation, User A will have the most current version of the persistent clipboard available to the active workstation. With the exception of requiring a connection to web server 508, the operation of the alternative embodiment of FIG. 5 is identical to the operation described above with reference to FIGS. 3 and 4, as will be readily apparent.

It is understood that the establishing of a connection between an active workstation and web server 508 can be accomplished numerous ways, including over a cable connection, dial-up connection (manual or automatic), DSL or other known methods for connecting to a web server including the HTTP and other web-oriented protocols. Further, it is understood that instead of using a web server, a web service, which is a known callable interface, can be used to provide web-based access to the persistent clipboard. The concept of a web service is known and information regarding web services can be found on the Internet at http://www.w3.org/TR/wsdl in a document titled “Web Service Description Language (WSDL) 1.1” (March 2001), which is incorporated fully herein by reference.

Because of the high probability that a user of the present invention will use multiple formats and operating systems when switching from one workstation to another, it would be optimal to adapt and reformat content, automatically, when such a format switch occurs. Accordingly, in accordance with the present invention, software that dynamically translates and optimizes content to ensure optimal operability on a particular workstation is utilized. As an example and without limiting the present invention to this example, IBM's WebSphere Transcoding Publisher™ is a server-based software that dynamically translates web content and applications into multiple mark-up languages and optimizes it for delivery to mobile devices, such as mobile phones and hand-held computers. Transcoding Publisher adapts, reformats and filters content to make it suited for pervasive computing. The transcoding is performed in real time and changes to the original content are automatically reflected when viewed by the user of the workstation. Thus, by providing transcoding capability to web server 508 (FIG. 5) or the portable memory medium such as the keychain memory device 399 (FIG. 3), clipboard content stored from a desktop system, which may have high level graphics capability and contain formatting that is memory-intensive can be viewed and used from a less powerful workstation (e.g., a PDA), with the transcoding that makes this possible occurring seamlessly in the background, unbeknownst to the workstation user.

Referring back to FIG. 4, both “paste” steps 403 and 405 include the option of transcoding the clipboard data being pasted so that it is pasted in a “target format.” The term “target format” as used herein means any format into which the clipboard content is transcoded based on the needs of the user of the workstation. This might occur, for example, when a user copies or cuts content at a desktop workstation, saving it to the persistent clipboard, and then retrieves it from the persistent clipboard using a less-powerful device, such as a PDA. The transcoding process to accomplish this format change is well-known; using the present invention, the transcoding takes place prior to the pasting of the content to the PDA.

The use of transcoding is not limited, however, to pasting of content from the persistent clipboard. For example, it may be desired to view a transcoded image in a device emulator running on the same PC from which the image has been “clipped”; using the present invention, when the image is retrieved from the local clipboard by the device emulator application, the transcoding process is executed before the paste take place.

Transcoding itself is a well-known technology, and a computer programmer of ordinary skill could readily and without undue experimentation configure the clipboard of the present invention to utilize transcoding technology as described herein. Further, it is contemplated that transcoding of all kinds (e.g., switching from one spoken or computer language to another language; converting from one word processing format to another word processing format, etc.) are encompassed by the transcoding feature of the present invention.

Although the present invention has been described with respect to a specific preferred embodiment thereof, various changes and modifications may be suggested to one skilled in the art. For example, while the above description sets forth specifically USB devices, floppy disks, CDR and CD-RW storage mediums as the portable devices that can be used in connection with the present invention, it is understood that any portable storage mechanism connectable via any interface (PCMCIA, etc.) can be used in connection with the present invention. It is intended that the present invention encompass such changes and modifications as fall within the scope of the appended claims.

We Claims:

1. In a system having clipboard capability for storage and retrieval of clipboard content to and from a local clipboard, a method for providing enhanced clipboard storage and retrieval, comprising the steps of:
providing an external storage location for external storage of said clipboard content;
storing clipboard content stored to said local clipboard also to said external storage location; and
providing retrieval capability selectively from either said local clipboard or said external storage location.

2. The method of claim 1, wherein said external storage location comprises a persistent memory.

3. The method of claim 2, wherein said step of storing clipboard content to said external storage location stores said clipboard content in a cumulative manner.

4. The method of claim 3, wherein said cumulatively stored clipboard content is time-stamped at the time of storage on said external storage location.

5. The method of claim 4, wherein upon receipt of a retrieval request by a workstation, said cumulatively stored clipboard data is displayed at the requesting workstation such that the cumulatively stored clipboard content is associated with its respective timestamp.

6. The method as set forth in claim 2, wherein said persistent memory comprises a portable USB device.

7. The method as set forth in claim 6, wherein said portable USB device comprises a memory key.

8. The method as set forth in claim 2, wherein said persistent memory comprises a floppy disk.

9. The method as set forth in claim 2, wherein said persistent memory comprises a CDR.

10. The method as set forth in claim 2, wherein said persistent memory comprises a CD-RW.

11. The method of claim 2, wherein said system is web-enabled, and wherein said persistent memory comprises a web server remotely accessible by said system.

12. The method of claim 2, wherein said system is web-enabled, and wherein said persistent memory comprises a web service remotely accessible by said system.

13. The method as set forth in claim 2, wherein said system comprises plural workstations, said storing step being performed in connection with a first of said workstations, further comprising the step of:
retrieving said contents of said external storage location from a second of said plural workstations.

14. The method as set forth in claim 13, further comprising the steps of:
determining if the content being retrieved by said second of said plurality of workstations requires transcoding to a format compatible with said second workstation; and
if it is determined that such transcoding is necessary, transcoding said clipboard content to said format prior to retrieval.

15. A system for providing enhanced clipboard storage and retrieval, comprising:
a processor providing clipboard functionality;
a local clipboard accessible by said processor;
an external clipboard storage device accessible by said processor; and
an external storage medium, accessible by said external clipboard storage device,
whereby clipboard content stored to said local clipboard is simultaneously stored to said external storage medium via said external clipboard storage device.

16. The system of claim 15, wherein said external storage medium comprises a persistent memory.

17. The system of claim 16, wherein said clipboard content is stored to said external storage medium in a cumulative manner.

18. The system of claim 17, wherein said cumulatively stored clipboard content is time-stamped at the time of storage on said external storage medium.

19. The system of claim 18, wherein upon receipt of a retrieval request by a workstation, said cumulatively stored clipboard data is displayed at the requesting workstation such that the cumulatively stored clipboard content is associated with its respective timestamp.

20. The system as set forth in claim 16, wherein said persistent memory comprises a portable USB device.

21. The system as set forth in claim 20, wherein said portable USB device comprises a memory key.

22. The system as set forth in claim 16, wherein said persistent memory comprises a floppy disk.

23. The system as set forth in claim 16, wherein said persistent memory comprises a CDR.

24. The system as set forth in claim 16, wherein said persistent memory comprises a CD-RW.

25. The system of claim 16, wherein said system is web-enabled, and wherein said persistent memory comprises a web server remotely accessible by said system.

26. The system of claim 16, wherein said system is web-enabled, and wherein said persistent memory comprises a web service remotely accessible by said system.

27. The system as set forth in claim 16, wherein said system comprises plural workstations, said storing of clipboard content to said external storage medium being performed in connection with a first of said workstations, further comprising:
means for retrieving said contents of said external storage location from a second of said plural workstations.

28. The system as set forth in claim 27, further comprising:
means for determining if the content being retrieved by said second of said plurality of workstations requires transcoding to a format compatible with said second workstation; and
means for transcoding said clipboard content to said format prior to retrieval if it is determined that such transcoding is necessary.
